(19) United States
(12) Patent Application Publication
(10) Pub. No.: US 2004/0034185 A1
(43) Pub. Date: Feb. 19, 2004

(54) Aminoplastic or phenoplastic adhesive with improved mechanical strength

(76) Inventors: Georges Lambiotte, Bruxelles (BE); Antonio Pizzi, Epinal (FR)

Correspondence Address: YOUNG & THOMPSON, 745 SOUTH 23RD STREET 2ND FLOOR, ARLINGTON, VA, 22202

(21) Appl. No.: 10/333,277

(22) PCT Filed: Jun. 22, 2001
(86) PCT No.: PCT/IB01/01109

(30) Foreign Application Priority Data
Jul. 17, 2000 (EP) 00115399.8

(51) Int. Cl. C08H 1/02

(52) U.S. Cl. 527/206

(57) ABSTRACT

The invention concerns an aminoplastic or phenoplastic adhesive with improved mechanical strength containing a C1-C6 alcohol acetal, and a method for increasing the mechanical strength of an aminoplastic or phenoplastic adhesive, which consists in adding to the adhesive composition a C1-C6 alcohol acetal.

The present invention concerns an improved amino resin or phenolic resin glue, and a method of increasing the mechanical strength of an amino resin or phenolic resin glue.

Glues of the amino resin or phenolic resin type are well known and used in many fields, for example in the manufacture of wood particle panels, plywoods, etc. In practice, it is known that one of the problems posed by the use of such glues consists of the emissions of formaldehyde which may occur both during the manufacturing process and during the aging of the manufactured products, which has moreover led many governments to lay down limits with regard to the formalin content of such glues.

On the other hand, the reduction in the molar ratio of the formalin results in a reduction in the mechanical strength of the glues and the products obtained by the use thereof. This problem has been partially resolved by the introduction of melamine to increase the mechanical strength, however not always in a completely satisfactory manner, and also leading to an increase in the cost of the glues and products obtained therewith.

The aim of this invention consists consequently of providing an amino resin or phenolic resin glue which has improved mechanical strength, independently of the melamine content thereof.

However, the present inventors revealed the fact, and this unexpectedly, that the addition of an acetal made it possible to increase the mechanical strength of such amino resin or phenolic resin glues.

Thus the first object of the present invention aiming to achieve the aforementioned aim consists of an amino resin or phenolic resin glue with improved mechanical strength which contains a C1 to C6 alcohol acetal.

A second object of this invention consists of a method for increasing the mechanical strength of an amino resin or phenolic resin glue, which is characterised in that a C1 to C6 alcohol acetal is added to the glue composition.

Preferably, the acetals added to the glues according to the present invention are methylal (dimethoxymethane) and ethylal (diethoxyethane).

With regard to the proportion of acetal in the glues, this is generally between 3 and 30%, and preferably from 10 to 20%.

More particularly, the glue compositions to which the present invention preferably applies are amino resin glues based on a urea-formalin mixture with a molar ration of 1/1.5, and those based on a melamine-urea-formalin mixture with a molar ratio of nitrogenous products to formalin of 1/1.2 to 1/1.5, and the phenolic resin glues based on a phenol-formalin mixture having a molar ratio of 1/1.7.

The present invention will now be described for illustrative and non-limitative purposes with reference to the following two examples, which are essentially intended to demonstrate the increase in the mechanical strength of the amino resin and phenolic resin glues according to the invention.

### EXAMPLE 1

### Thermo-mechanical Analysis (TMA)

(a) Preparation of Adhesive Mixtures:

For urea-formalin (UF) and melamine-urea-formalin (MUF) glues, there are added to 100 parts by weight of glue, whose solid content is 60%, 1.8, 6 and 12 parts by weight methylal, or respectively ethylal (for mixtures with 3.10 and 20% acetal) and 7.5 parts of a solution with 20% hardener (ammonium chloride or sulphate).

For phenol-formalin (PF) glues, the same procedure is followed, except that there is no addition of hardener.

(b) Operating Method:

The principle of this method is based on a system of modelling the pressing of panels obtained by the assembly of two wafers by means of the glue to be analysed, and the quality of the assembly obtained being directly related to that of the adhesive mixture used.

More particularly, 30 mg of adhesive mixture is deposited between two wafers of beech, and the assembly thus obtained is disposed on a support, so that assembly is supported by its two ends, and the whole is placed in an oven.

The oven is subjected to a programme of increase in temperature from 25 to 250° C., at the rate of 10° C./min, which results in a hardening of the glue between the two wafers, and the formation of a single wafer of solid wood. During the temperature rise, a force is applied vertically (F=30 g) in the middle of the wafer, this force causing a bending (f) which makes it possible to determine the modulus of elasticity. This bending (f) decreases according to the temperature, demonstrating an increase in mechanical strength.

The equipment used in this experiment was a “METTLER TMA 40” thermomechanical analyser, connected to a processor and computer making it possible to record the thermograms and to process the data obtained.

More particularly, and for each sample tested, the deflection (f in μm) was measured as a function of temperature, and the modulus of elasticity (E in Mpa) was calculated in accordance with the equation:

E=[1/(f−3.2)]0.47386.

(c) Results:

In Table I below, the results obtained for amino resin glues (of types UF and MUF) are set out.

TABLE I

| | Maximum modulus of elasticity (corrected mean) of | | |
|---|---|---|---|
| | the adhesive mixtures (Mpa) | | |
| Additive | UF glue 1/1.5 | MUF glue 1/1.2 | MUF glue 1/1.5 |
| Reference | 1543 | 2210 | 2867 |
| Methylal | | | |
| 3% | 2444 | 2523 | 3026 |
| 10% | 2460 | 3816 | 4418 |
| 20% | 1889 | 3933 | 5597 |
| Ethylal | | | |
| 3% | 2172 | 2553 | 3398 |
| 10% | 2238 | 4459 | 3506 |
| 20% | 2390 | 3164 | 4773 |

The results obtained for a phenolic resin glue (of PF type) are set out in Table II below.

TABLE II

| | Maximum modulus of elasticity (corrected |
|---|---|
| | mean) of the adhesive mixtures (Mpa) |
| Additive | PF glue 1/1.7 |
| Reference | 2126 |
| Methylal | |
| 3% | 2156 |
| 10% | 2432 |
| 20% | 3250 |

The results appearing in Tables I and II clearly demonstrate the effect of acetal on the modulus of elasticity measured, and consequently on the increase in mechanical strength obtained with amino resin and phenolic resin glues.

### EXAMPLE 2

### Measurement of Tensile Strength on Particle Panels

(a) Preparation of the Panels:

The quantities indicated in g in Table III below of the various constituents were added to 1000 g of dry wood particles.

TABLE III

| | Sample N° | | | |
|---|---|---|---|---|
| | 1 | 2 | 3 | 4 |
| Dry wood | 1000 | 1000 | 1000 | 1000 |
| MUF 1/1.1 glue | 167 | 167 | 133 | 100 |
| in solution at 60% | (100) | (100) | (80) | (60) |
| (in solid equivalent) | | | | |
| 20% solution of | 7.5 | 7.5 | 6.0 | 4.5 |
| ammonium chloride | | | | |
| Methylal | — | 10 | 8 | 6 |

The panels were pressed at a surface temperature of 190° C., at a maximum pressure of 28 kg/cm² with a pressing cycle of 3 min for a final panel thickness of 14 mm (pressing time: 12.8 sec/mm).

(b) Results:

On the panels thus obtained, measurements of tensile strength were carried out, using a normal method (as described for example in European standards EN 300, 313 and 319). The results obtained are set out in Table IV below:

TABLE IV

| | | Reduction in |
|---|---|---|
| | Tensile strength | quantity of glue |
| Sample 1 (reference) | 1.011 | — |
| Sample 2 | 1.335 | — |
| Sample 3 | 1.026 | 20% |
| Sample 4 | 0.826 | 40% |

It emerges first of all from these results that, all other parameters being identical, the tensile strength obtained is appreciably improved for Sample N° 2 compared with the reference (Sample N° 1).

In addition, the presence of methylal makes it possible to reduce the quantity of glue, whilst keeping a comparable tensile strength (Samples 3 and 4 compared with the reference).

Having regard to the above, and by virtue of the present invention, it is possible to obtain a reduction in the costs of manufactured panels, and in particular a reduction in formaldehyde emissions, both during production and during the aging of the panels.

In addition, melamine being introduced into the UF glues in order to increase their mechanical strength, the presence of an acetal therefore makes it possible to reduce the quantity of melamine necessary for an equivalent mechanical strength, which also contributes to a reduction in the prices of the glues and panels manufactured therewith.

Finally, it should also be noted that the presence of acetal in an amino resin or phenolic resin glue increases the compatibility of the latter with water.

A glue increases, after preparation, its degree of polymerisation over time; the glue is then said to be more “advanced”, which results in increasing the speed of reaction of the said glue during its use. However, a more polymerised glue reduces its compatibility with water and therefore its suitability for being diluted.

The fact that the presence of acetal in a glue increases its compatibility with water therefore has a dual consequence, namely on the one hand, for the same degree of polymerisation, the compatibility with water is increased, and on the other hand, for the same compatibility with water, the degree of polymerisation, and therefore the reaction speed during use, can also be increased.

1. Amino resin or phenolic resin glue with improved mechanical strength, characterised by the fact that it contains a C1 to C6 alcohol acetal.

2. Glue according to claim 1, characterised by the fact that the acetal is methylal or ethylal.

3. Glue according to claim 1 or claim 2, characterised by the fact that it contains 3 to 30% acetal, and preferably 10 to 20%.

4. Amino resin glue according to one of claims 1 to 3 based on a urea-formalin mixture with a molar ratio of 1/1.5.

5. Amino resin glue according to one of claims 1 to 3, based on melamine-urea-formalin mixture with a molar ratio of nitrogenous products to formalin of 1/1.2 to 1/1.5.

6. Phenolic resin glue according to one of claims 1 to 3 based on a phenol-formalin mixture with a molar ratio of 1/1.7.

7. Method for increasing the mechanical strength of an amino resin or phenolic resin glue, characterised by the fact that a C1 to C6 alcohol acetal is added to the glue composition.

8. Method according to claim 7, characterised by the fact that 3 to 30% and preferably 10 to 20% methylal or ethylal is added to the glue composition.
